(19) United States
(12) Patent Application Publication
(10) Pub. No.: US 2009/0083187 A1
(43) Pub. Date: Mar. 26, 2009

(54) MAIL STERILIZATION INDICATOR

(75) Inventors: Douglas B. Quine, Bethel, CT (US); Bertrand Haas, New Haven, CT (US); Seema K. Winsor, Stamford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/861,349

(22) Filed: Sep. 26, 2007

(51) Int. Cl. G07B 17/00; G06K 9/60

(52) U.S. Cl. 705/62; 209/584; 235/462.01; 235/487; 705/410

(57) ABSTRACT

A mail piece having a sterilization indicator includes an irradiation status area applied to a part of said mail piece. The irradiation status area is adapted to be activated by radiation. The irradiation status area has a first color prior to activation by radiation. The irradiation status area has a second color subsequent to activation by radiation. A method for the processing a mail piece having a sterilization indicator embodying the present invention includes the steps of introducing the mail piece into a postal processing system. The mail piece has an irradiation status area which is adapted to be activated by radiation. The mail piece is radiated and processed to determine whether the radiation has activated the irradiation status area.

### FIELD OF THE INVENTION

The invention relates generally to insuring the safety of mailing and other systems and, more particularly, to enhancing mail and mailing system protection with mail sterilization indicators and methods for determining the status of mail piece sterilization for hazardous materials, such as anthrax.

### BACKGROUND OF THE INVENTION

The anthrax attacks of 2001 in the United States alerted the public to the potential for hazardous materials to pass through the mail. Intending to cause harm, life threatening deadly anthrax was introduced into envelopes that were mailed to recipients. The mail with appropriate postage applied was deposited into a letter collection mail box, subsequently collected by a postal employee and thereafter entered the United States Postal Service (USPS) mail processing system. The mailings resulted in contamination of the Hart Office Building, Brentwood Postal Facility (DC), and Hamilton Postal Facility (NJ) facilities that processed these envelopes. Various items of mail were cross-contaminated with anthrax. That is, mailing items not containing anthrax became contaminated with anthrax due to processing at the USPS facilities of envelopes containing anthrax. The huge costs associated with decontamination and the vulnerability of essential government facilities to anthrax attacks were made clear by the hundreds of millions of dollars associated with the cleanup of the Hart Office Building, Brentwood Postal Facility, and Hamilton Postal Facility.

To help protect the mail, the USPS obtained and employs high power x-ray systems, originally intended for food sterilization, for the sterilization, that is, decontamination of mail destined for delivery to government offices in Washington D.C. The USPS irradiates letter mail destined to government offices in Washington D.C. with high power x-rays. The irradiation system kills any anthrax and other harmful materials that may be contained in the mail in the mail batches that are irradiated. This mail, envelope and contents, may enter the postal processing system through normal entry points such as collection mail boxes, mail drops, post office deposit receptacles and the like. The mail may include proof of postage payment such as preprinted USPS adhesive postal stamps affixed to the envelope, postage meter indicia printed directly on the envelope (or on a label affixed to the envelope), or printed USPS mail permits. The postage meter indicium can be printed by any of the commercially marketed postage meters such as those employing thermal printing or ink jet printing technologies.

The high power x-ray irradiation also causes other physical changes to the mail. For example, at the irradiation levels employed by the USPS, glassine envelope material becomes brittle, laser printed text may transfer to adjacent sheets of paper, and envelopes become slightly darkened. The high heat may also cause thermally printed information, including postage indicia, to discolor and/or darken. The changes depend on the types of materials, envelope, envelope contents, and inks employed in preparing the mail piece.

Although individuals with specific knowledge of the irradiation process can predict whether mail has been irradiated by examination of the mail and observation of discoloration (compared with reference materials), brittle windows, and fused laser print, there is currently no direct, easy and quick means for mail recipients and other people who come into contact with mail to identify whether a specific item of mail has been irradiated and is safe. Additionally, there is currently no direct, easy, and quick means for people to determine the extent of any mail irradiation or a method to help automate the processing of mail which may or may not have been irradiated.

Prior art in the area of irradiation and related fields includes radiation badges employing photographic film which are darkened by exposure to x-rays indicating exposure to excessive radiation (requires photographic film development and analysis to obtain test results). Checks that reveal a “void” message when they are copied or altered utilize a different property. These items are not altered by the scanning process, rather an optical interaction between the security printing on the text and the copier evidences the “void” text. The actual check remains unaltered. Bacterial spore strips are used to prove that autoclaves have successfully sterilized medical equipment or mail. Test strips are placed inside the autoclave and subsequently cultured in a laboratory. The number of spores observed is compared with reference test strips which were not autoclaved. Liquid crystal thermometer displays with no moving parts having a color and/or gray level scale can show current temperature conditions but they do not change state and report upon historical conditions they have endured. Secure (e.g. MCI) visitor's badges are available which change state overnight and reads “VOID” the following day. These C-Line (1100 Business Center Drive, Mt. Prospect, Ill., 60056) “Time's Up!™ Self-Expiring One-Day VOID Visitor's Badges” are based upon a backing material with a dark encapsulated ink and a name badge with a light colored background which is applied on top. Through time, the dye penetrates the name tag from behind resulting in a darkened expiration message. Systems have been developed which seek to detect harmful materials or sterilize mail. An example of such a system is U.S. Pat. No. 7,165,053 of Christian A. Beck, assigned to Pitney Bowes Inc., for “SYSTEM AND METHOD FOR PRE-FEEDING MAILPIECES, DETECTING THE PRESENCE OF HARMFUL MATERIALS IN THE MAILPIECES AND SORTING THE MAILPIECES”. This approach is helpful but provides no means to utilize the sterilization process itself to directly drive the sortation process. None of these prior techniques provide a direct, easy, and quick means for people to identify whether their mail is safe, the extent of any mail irradiation nor any cost effective method which automates batch mail processing where radiation may be involved in a way that insures safe and efficient mail processing.

### SUMMARY OF THE INVENTION

It is an object of the present invention to provide a direct, easy, and quick means for people to identify whether mail is safe.

It is a further object of the present invention to provide a direct, easy, and quick means for people to determine the extent of any mail irradiation.

It is yet further objective of the present invention to provide a method to help automate the processing of mail which may or may not have been irradiated.

It is another object to help avoid alarm by people that may come into contact with a mail piece due to the changed nature of an irradiated mail piece;

It is yet another object of the present invention to provide an explicit indication whether a mail piece has been through the irradiation process.

A mail piece having a sterilization indicator embodying the present invention includes an irradiation status area applied to a part of said mail piece. The irradiation status area is adapted to be activated by radiation. The irradiation status area has a first color prior to activation by radiation. The irradiation status area has a second color subsequent to activation by radiation.

A method for the processing a mail piece having a sterilization indicator embodying the present invention includes the steps of introducing the mail piece into a postal processing system. The mail piece has an irradiation status area which is adapted to be activated by radiation. The mail piece is irradiated and processed to determine whether the radiation has activated the irradiation status area.

### DESCRIPTION OF THE DRAWINGS

The accompanying drawings, which are incorporated in and constitute a part of the specification, illustrate presently preferred embodiments of the invention, and, together with the general description given above and the detailed description of the preferred embodiments given below, serve to explain the principles of the invention. As shown throughout the drawings, like reference numerals designate like or corresponding parts.

FIG. 1 is a representation of an envelope embodying the present invention bearing thermal status labels before irradiation with high power x-rays;

FIG. 2 is a representation of the envelope shown in FIG. 1 after being irradiated with high power x-rays where the thermal status labels have been activated to indicate that the mail piece has been irradiated.

FIG. 3. is a representation of another envelope embodying the present invention before irradiation with high power x-rays, bearing on the left side of the envelope surface a thermal label with white opaque ink text on top, in the middle of the envelope surface a second thermal label with black permanent marker text on top and on the right side of the envelope surface a third thermal label with cutout text;

FIG. 4 is a representation of the envelope shown in FIG. 3 after being irradiated with high power x-rays where the three thermal status labels have been activated and a new barcode revealed to indicate that the mail piece has been irradiated;

FIG. 5 is a representation of another envelope embodying the present invention before irradiation with high power x-rays bearing a thermal postage meter label imprinted with postage and a personalized picture and also including cutout text;

FIG. 6 is a representation of the envelope shown in FIG. 5 after being irradiated with high power x-rays where the thermal label imprinted by the meter has been activated to indicate that the mail piece has been irradiated;

FIG. 7 is a representation of an envelope embodying the present invention before irradiation with high power x-rays bearing a thermal status label with a graphic;

FIG. 8 is a representation of the envelope shown in FIG. 7 after being irradiated with high power x-rays where the thermal label with graphic has been activated to indicate that the mail piece has been irradiated;

FIG. 9 is a is a representation of a label embodying the present invention before irradiation with high power x-rays, a portion of the label includes a scale printed with an ink that is not significantly affected by high power x-rays adjacent a label portion with text that is significantly affected by high power x-rays;

FIG. 10 is a representation of the label shown in FIG. 9 after being irradiated with high power x-rays where the thermal label portion has been activated to indicate that the mail piece has been irradiated and enabling a determination of the level of irradiation; and,

FIG. 11 is a representation of a basic process for automating the handling of mail which may or may not have been irradiated with high powder x-rays to render the mail pieces safe.

FIG. 12 is a representation of a more comprehensive process for automating the handling of mail which may or may not have been irradiated with high powder x-rays to render the mail pieces safe.

### DETAILED DESCRIPTION OF THE PRESENT INVENTION

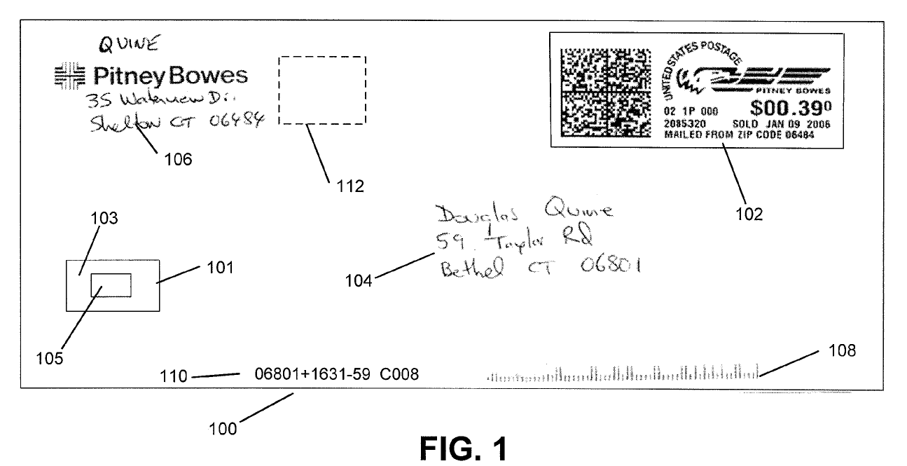

In describing the present invention, reference is now made to the various figures wherein like reference numerals designate similar elements in the various views and specifically to FIG. 1. An envelope 100, before irradiation by X-rays, includes a postage meter indicium 102, addressee information shown generally at 104, sender information shown generally at 106, and various postal markings. This includes a POSTNET barcode shown at 108 and human readable ZIP code and carrier route information shown at 110. These markings 108 and 110 have been generated/printed on the envelope by the USPS postal automation equipment, specifically the Multi-Line Optical Character Reader (MLOCR) system. The meter indicium 102 can be imprinted either directly on the envelope or on a label affixed to the envelope, as is shown in FIG. 1. The indicium itself can be by any commercial postage meter and may employ thermal printing technology, as is the case with FIG. 1, or other printing technologies, including ink jet printing technology or laser printing technology. The envelope 100 further includes an irradiation status area, faintly visible and shown at area 112. This irradiation status area can be an irradiation status label that is affixed to the envelope 102, as is shown in FIG. 1, or a portion of the envelope which is coated with a material that indicates irradiation status. The irradiation status area can be on any part of the mail piece. That includes the outer surface of the mail piece, such as a package or envelope and the contents of the mail piece. Moreover, where desired, the irradiation status area can be on a portion of the contents that is visible through a window in the outer surface of the mail piece, such as a glassine window or a cut out. Envelope 100 includes a cut-out 101 with an irradiation status area 105 applied to the envelope contents 103 and visible through window cut out 101. This can be helpful when the envelope and contents are separated so that people will know the irradiation status of the envelope and also of the envelope contents.

The irradiation status area is sensitive to the mail sterilization and decontamination procedures and is used to indicate when the mail has been successfully sterilized. Although thermal print media are a preferred embodiment which has been tested and demonstrated to be effective on live mail, other materials which are sensitive to mail sterilization and exhibit physical changes can be employed.

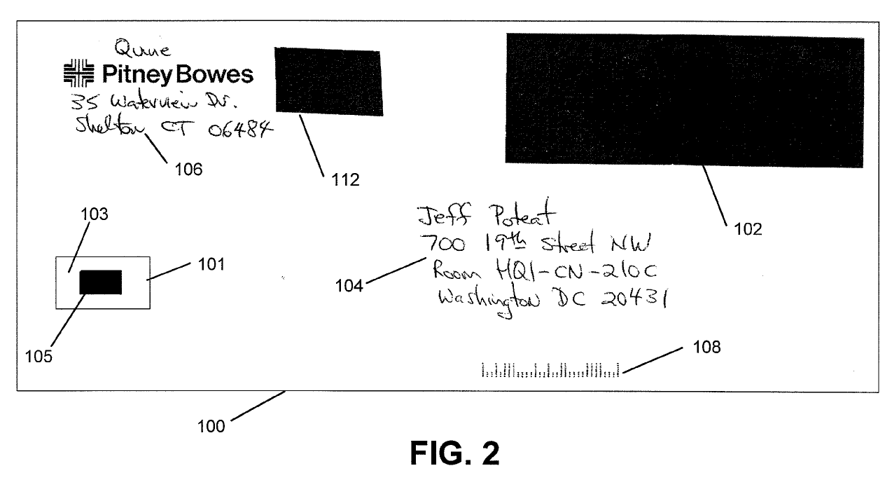

Reference is now made to FIG. 2. Envelope 100 is shown after having been irradiated with high power x-rays. Changes are noted in the irradiation status area 112 and also in the meter indicium 102. The substantially invisible irradiation status areas 105 and 112 and the readable meter indicium 102 have changed to three darkened areas. The thermal media material and the meter indicium label stock can be selected to control the appearance to match the color of the envelope and/or envelope contents when applied before irradiation, and to have a substantial, different color after irradiation. The meter indicium 102 after irradiation is obscured such that the postal amount of 39 cents and the 2-D barcode at the left side of the meter indicium as well as other information on the meter indicium are fully obliterated. However, where the meter indicium is from technologies other than thermal technologies, the meter indicium 102 may remain visible. Moreover, the substrate used for the postage meter indicium 102 and the level of irradiation sensitivity can be selected such that the indicium can remain readable after irradiation.

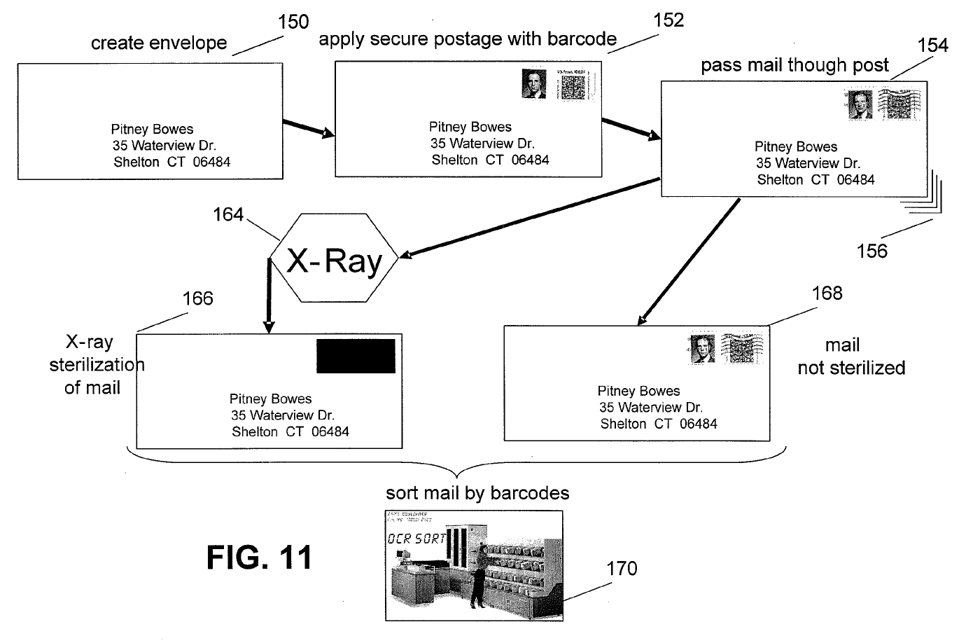

As will be explained more fully in connection with FIG. 11, barcode readability degradation or enhancement can be employed as a means to automatically process irradiated mail differently or to rerun inadequately treated mail based on the readability or lack of readability of the barcode. Whether the barcode readability is degraded or enhanced depends on where and how the barcode is applied. The barcode can become readable or not readable. Also the barcode can become less readable or more readable providing a further indication of the level of irradiation of the mail piece.

Depending upon how the mail is processed, it may be desirable to image the mail piece prior to irradiation to preserve the information in its unaltered condition. Additionally, it may be desirable to employ printing technologies for the meter indicia which are not sensitive in their entirety to irradiation. This may involve a combination of thermal and non-thermal printing technology. For example, the use of thermal and laser printing technologies where the indicia would not be entirely sensitive to irradiation can be employed. In such case, indicia information desired to be preserved, for example, a barcode, can be preserved in sufficiently unaltered condition so that the barcode remains readable after irradiation.

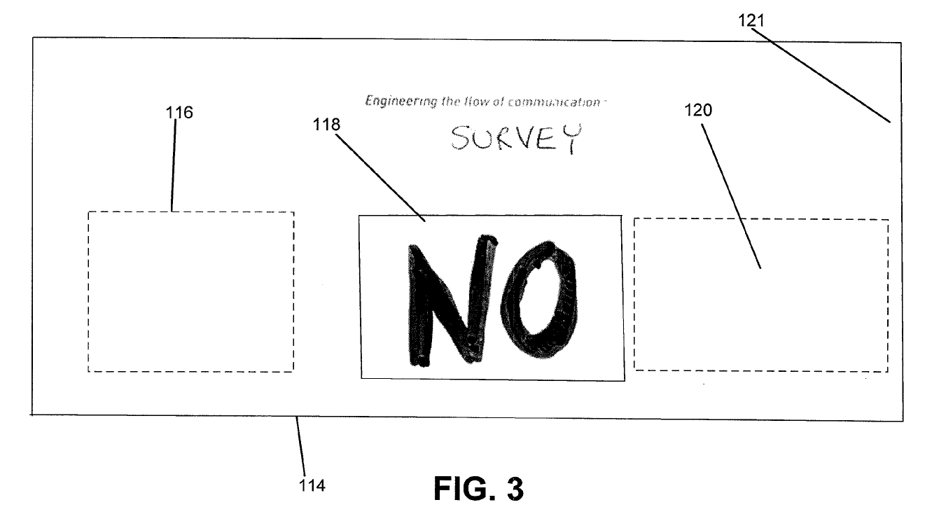

Reference is now made to FIG. 3. Envelope 114 includes three irradiation status areas 116, 118 and 120. These three areas are shown before the irradiation of the envelope 1 14 with high-power X-rays and are located on the rear flap surface 121 of the envelope. These three irradiation status areas, as with other irradiated status areas, can be located on any suitable real estate on the envelope surfaces or contents (the x-ray irradiation reaches all surfaces and the contents of the envelope). Irradiation status areas 116 and 120 are a color which is similar to the color of the envelope surface and are substantially invisible to the human eye. Irradiation status area 118, however, includes a visible portion, with the image of the word “NO” appearing on the envelope. This indicates that the envelope 114 has not been irradiated. Any message to indicate the lack of irradiation can, of course, be employed. The irradiation status areas may also include an invisible barcode. The invisible barcode can be written in a permanent ink that matches the color of the envelope and becomes visible upon irradiation or can be cut out of a thermal security label.

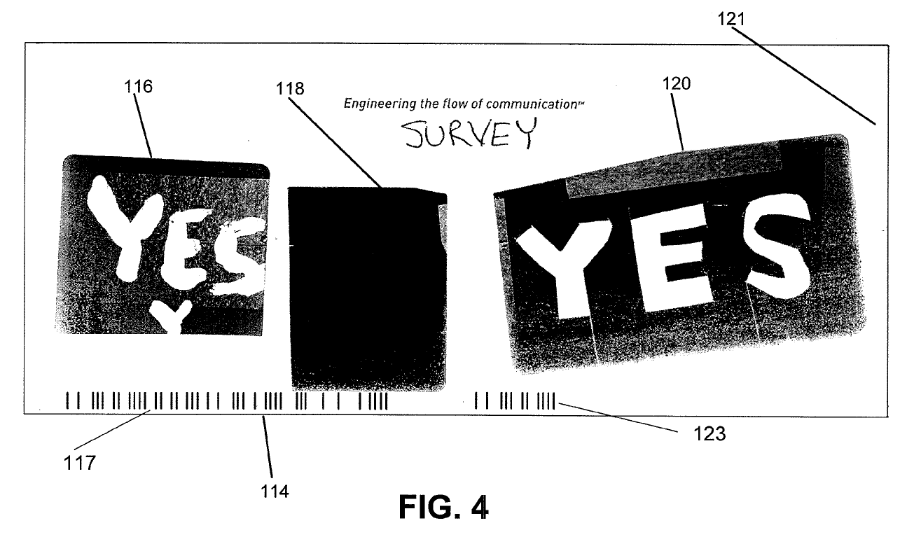

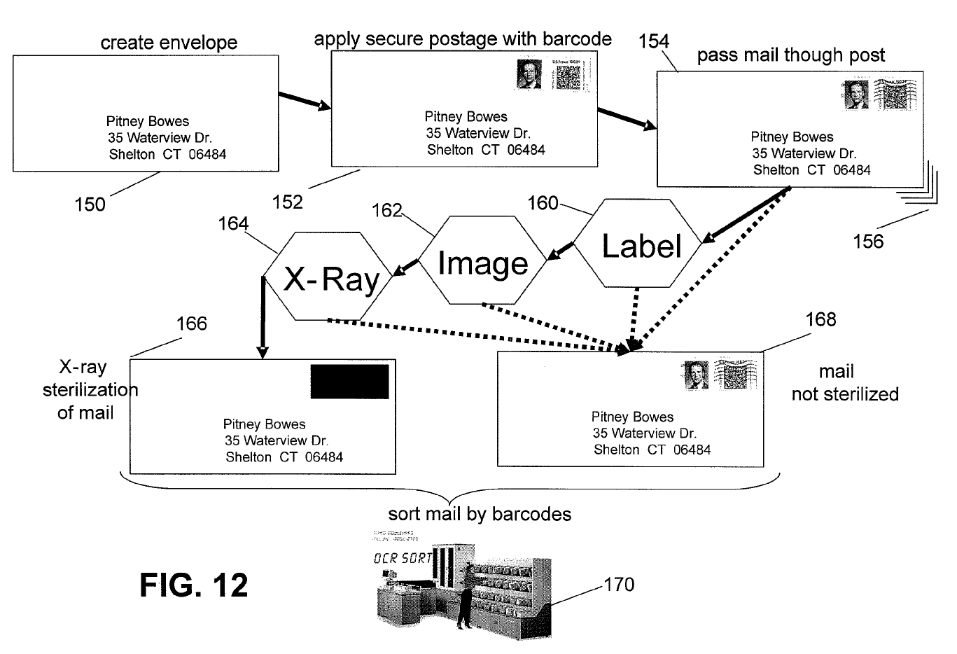

Reference is now made to FIG. 4, which depicts envelope 114 and the three irradiation status areas after irradiation. The irradiation status areas 116 and 120, when activated by the high-power X-rays, exhibit an image of the word “YES” while the irradiation status area 118 has the image of the word “NO” substantially obscured. The changes are due to the darkening of the thermal label materials of the status portions 116, 118 and 120. The thermal material used in the status portion 120 has a die cut out to form the word “YES,” which becomes highlighted due to the darkening of the surrounding thermal material. The white overprinted text has become visible on label 116 against the contrasting dark media. Also, the invisible barcode 123 becomes visible. Barcode 123 can be employed to sort irradiated mail and process it differently from non-irradiated mail. Barcodes which only appear after irradiation are thus available to automatically process irradiated mail differently from mail which was not irradiated. Alternatively, black barcodes may be preprinted on the thermal meter indicia label stock which will disappear when irradiated and no longer be readable to force reprocessing of inadequately treated mail based on the lack of readability of the barcode. The USPS has also applied a fluorescent piece identification barcode (previously known as a Remote Bar Coding System barcode) 117 to the back of the envelope. This may be utilized for piece verification as discussed with respect to FIG. 12.

Thus, before irradiation, the image of the word “YES” on irradiation status area 116 and on irradiation status area 120, as well as the barcode 123, are all obscured. The word “NO” on thermal label portion 118 is written in an ink, the color of which substantially matches the color of the thermal portion 118 after irradiation. Thus, the image of the word “NO” fades into the background of the irradiated portion 118 after irradiation. The image of the word “NO” remains visible, as shown in FIG. 4, with less contrast in its surrounding area than shown in FIG. 3. The inks can be matched to make the image of the word totally disappear, partially disappear, or, in the case of the thermal material dye-cutouts on irradiation status area 120, opaque text on 116, and barcode 123 within its own irradiation status area, become vivid. Rather than employing cutouts for the irradiation status areas 120, an ink that matches the color of the irradiation status area 116 before irradiation, such as those employed for barcode 123, can be employed for the image of the word “YES,” which becomes vivid when the irradiation status area background darkens or changes color. The barcode or other code may also be implemented as a cut-out in an irradiation status area.

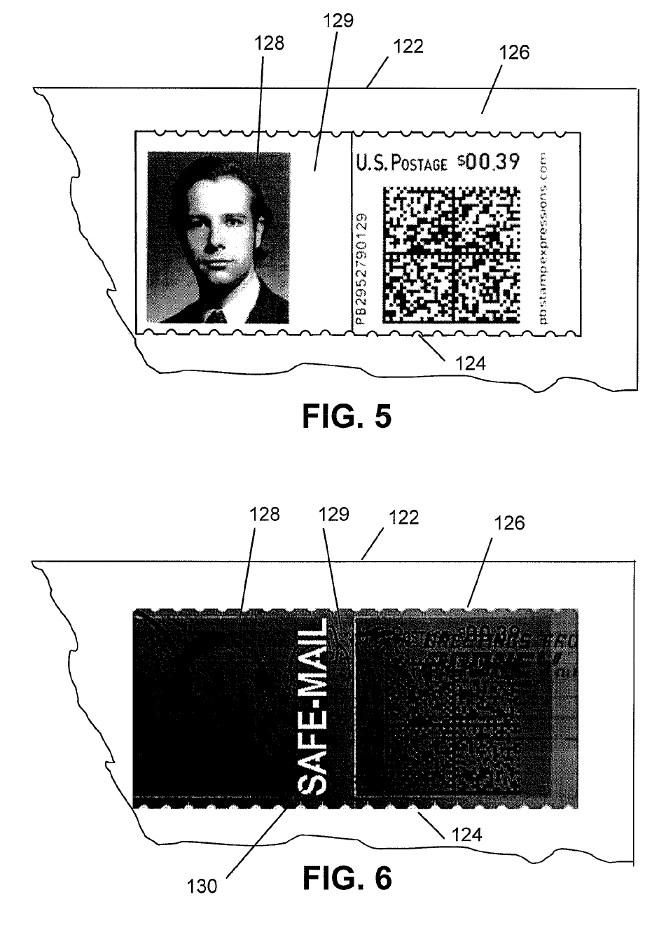

Reference is now made to FIG. 5. A portion of an envelope 122 is shown with a thermal postage meter label imprinted with postage and a 2-D barcode shown in area 126 and a personalized picture shown in area 128. The postage meter label 124 also includes an irradiation status area 129 with a cutout text or an ink text of the same color as the meter label 124 before irradiation.

Reference is now made to FIG. 6, showing the envelope 122 after being irradiated with high-power X-rays. The irradiation status area 129 of thermal label 124 has been activated by the high-power x-rays to indicate that the mail piece has been irradiated. The portions 126 and 128 of the meter indicium have become darkened and the irradiation status area activated with the image of the words “SAFE-MAIL” 130 has become vivid. It is noted that the 2-D barcode is not fully obscured and may retain sufficient readability for forensic or revenue protection analysis. Moreover, the image portion 128, although darkened, is still recognizable and, additionally, another obscured portion adjacent the image, specifically 129, has become visible. This brighter image 129 is associated with the ultraviolet taggant ink (which remains effective after irradiation) applied to the meter indicium for mail facing and other postal operations. Regions can also be imprinted with an media ink which is similar to the thermal meter label 124 before irradiation but changes color to become a different color, although still a contrasting color from the label 124 after irradiation. Thus, the image portion 129 is invisible to the eye before irradiation, as shown in FIG. 5, and becomes visible after irradiation. This provides a further security technique to show that the mail has been irradiated. Such revealed areas can be changed periodically to yet further enhance security.

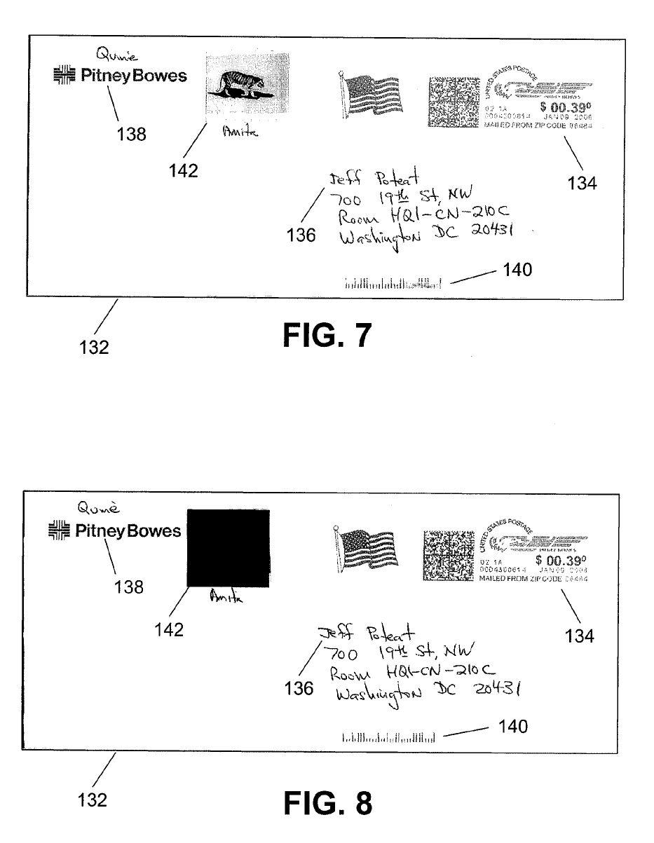

Reference is now made to FIG. 7. An envelope 132 shown before irradiation includes a meter indicium 134, addressee information 136, sender information 138, and a barcode 140. The envelope 132 also includes an irradiation status area, a label 142 with a graphic image of a tiger. The meter indicium 134, addressee information 136, sender information 138, and POSTNET barcode 140 (applied by mailer or USPS) are printed in inks that are not subject to color change upon being irradiated with high-power x-rays. Examples of such inks would include fluorescent meter ink, laser toner ink, ball point pen ink, indelible marker ink, “white out”, and offset print ink.

Reference is now made to FIG. 8. As can be seen, the information imprinted on the envelope at 134,136,138 and 140 remain substantially unchanged after irradiation by high-power X-rays. However, the irradiation status area 142 has changed color. The image of the tiger is obscured and has faded into the background of the irradiation status area 142. This provides a visual indication that the envelope 132 has been irradiated.

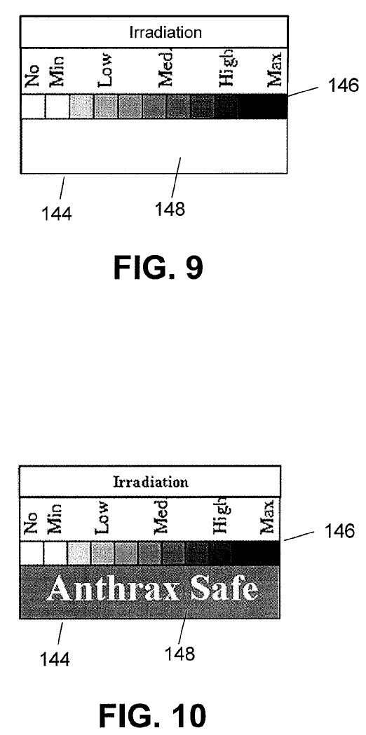

Reference is now made to FIG. 9, showing a label 144 before irradiation with high-power X-rays. A portion of the label includes a scale 146 with progressive areas of different shades of color from white to black. Different scales may be used, depending on the materials being employed. The scale 146 is printed with an ink that is not significantly affected by high-power X-rays. Adjacent to scale 146 is an irradiation status area 148 that is affected by high-power X-rays. The irradiation status area 148 can have a cutout text which is invisible before irradiation or printed text in an ink which matches the color of irradiation status area 148 so as to not be visible.

Reference is now made to FIG. 10, showing label 144 after irradiation with high-power X-rays. The thermal portion of the label has been activated and has changed color to indicate that the mail piece has been irradiated. The image of the words “ANTHRAX SAFE” has become visible due to the change in the color of the irradiation status area 148. Additionally, the change in color of the irradiation status area 148 allows a color match to be made between the printed scale 146 and the other irradiation status area 148. This enables determination of the level of irradiation of the label 144 and, thus, any mail piece to which it is attached. The color of the irradiation status area 148 matches the medium irradiation color point on the scale 146. The printed words adjacent the color scale 146 indicate the level of irradiation.

Where the irradiation status area 148 remains white, no irradiation has occurred and when the irradiation status area 148 turns completely black, maximum irradiation has occurred. The scale and printed information adjacent the scale allows determination by comparison of the color of the irradiation status area to the color scale 146 whether no irradiation has occurred, minimum irradiation has occurred, lower irradiation has occurred, medium irradiation has occurred, high irradiation has occurred, or maximum irradiation has occurred. As previously noted, the nature of the scale color can be selected to accommodate the particular application and the specific irradiation process and the specific materials employed. The determination of irradiation can be done both visually and also through machine processing, for example, by employing a calorimeter, which detects the color of the irradiation status area 148 and matches it to pre-determined color levels.

Reference is now made to FIG. 11, showing a flow diagram of the process for automating the handling of mail which may or may not have been a part of a batch of mail irradiated with high-power X-rays to render the mail piece safe. At 150, an envelope is prepared with addressee information. The envelope 150 may have any or all of the irradiation status area types described above, such as labels and any variant thereof. At 152, the envelope has secure postage with a barcode applied. Again, the secure postage may include any of the previously-described forms or variations of irradiation status areas. Moreover, the envelope itself can include pre-prepared status areas and can include multiple types of irradiation status areas that are applied as part of the physical fabrication of the envelope and/or envelope contents or at any point in the preparation of the mail piece. At 154, the mail passes through the post as part of the mail processing and becomes part of a batch of mail 156. The mail may either be irradiated with high power X-rays at 164, resulting in a mail piece at 166 that has been sterilized, or not sterilized, as shown at 168. The mail piece may be irradiated with high power X-rays as part of a large batch of mail. The processing at 170 of the sterilized and non-sterilized mail can include sorting the mail by various markings such as barcodes and by gray-scale comparison and/or by other techniques to segregate for further processing and/or for delivery of mail that has been irradiated and mail that has not been irradiated.

For example, mail that has been irradiated may be sorted for shipment to the recipients. Mail that has not been irradiated can be sent for re-processing and irradiation. The sorting enables irradiated mail to be retained, pending irradiation of the non-irradiated or insufficiently irradiated mail and/or the analysis to determine whether any of the mail contained anthrax or any other harmful materials that could have cross-contaminated irradiated mail items or postal equipment. Various processing can be implemented to facilitate the handling of the mail. Moreover, the irradiation can be such, similar to that shown in FIGS. 3-4, 5-6 and 7-8 where the various barcodes and information are either not fully obliterated or becomes readable due to the sterilization and/or are not sensitive to irradiation to be employed, so as to facilitate further processing.

Barcode contrast on irradiation sensitive media will change as the thermal media are irradiated and darken. This characteristic could be utilized for security screening. As the irradiation dose is increased (greater effectiveness), the barcode contrast will change and readability will be reduced or enhanced and readability will be altered. This effect could be used to cause any readable or non-readable barcode to reroute a mail piece for further irradiation or to signal that the system was not operating properly. This could be utilized as a means to create a closed loop mail sterilization/decontamination system with continuously graded responses where gray levels such as shown in FIGS. 9-10 provide measure of irradiation dose. Barcode degradation or enhancement could be used as a means to automatically process irradiated mail differently or to rerun inadequately treated mail.

Barcode contrast change can be employed as part of using automated feedback or monitor. The mail piece may contain a barcode that could be a data matrix barcode or other two-dimensional barcode, one-dimensional POSTNET barcode or PLANET barcode. These can be employed to have an automated scoring system to see whether a mail piece has actually been irradiated by reading the barcode. If the barcode were printed black on white, when the label turns black, the barcode will become invisible. The system can run these mail pieces through a reader, and mail pieces that “read” have not been irradiated or insufficiently irradiated. Such mail pieces can be outsorted.

The system can be designed to outsort the non-irradiated mail, or reverse the logic, and print the barcode as a cut-out or in specific color ink that matches a non-irradiated irradiation status area and then when the barcode appears after irradiation, the barcode would indicate that the mail piece was irradiated and/or that the system working properly. The presence, or absence of, the barcode or the changed state part of the barcode or other code or marker, is used to outsort mail. One arrangement is where the barcode disappears and the lack of barcode is used to outsort the mail piece. Another arrangement is where the barcode appears and the barcode is used to outsort the mail piece. Two barcodes can be employed for redundancy, such as a barcode that disappears and a barcode that appears when the mail piece is radiated to activate the irradiation status areas.

If envelopes are irradiated that contain suspicious powders, the biological materials would be expected to be rendered non-viable. However, because of possibility of cross-contamination, the system may be implemented such that if any mail is not irradiated or insufficiently irradiated, all the mail may be withheld pending further action. For example, if some letters or packages contaminated with anthrax are not irradiated or are not irradiated enough, none of the mail may be deemed to be safe because the non-irradiated pieces may cause new cross-contamination of the irradiated mail. Accordingly it may be desirable to re-irradiate the entire batch of mail or to conduct further testing of the non-irradiated letters.

Reference is now made to FIG. 12, showing an expanded flow diagram of the process for automating the handling of mail. In addition to the features already discussed with regard to FIG. 11, steps 160 and 162 have been added. Step 160 allows the addition of thermal status labels to all mail pieces (not all mail pieces necessarily have thermal status labels or postage meter indicia when they are mailed). Step 162 allows the imaging of each mail piece before it is passed through x-ray irradiation to ensure that a terrorist has not attempted to trick the system by affixing a black “thermal status label” to the mail piece in advance. By reading the USPS unique identification barcode 117 (FIG. 4), mail pieces can be imaged before irradiation and then compared afterwards during the sortation process 170 to ensure that the labels were not black before irradiation.

As can be seen from the various embodiments described above, irradiation status areas, such as status labels, specific types of meter indicia and images which are sensitive to mail sterilization and decontamination practices are used to indicate when mail has been successfully sterilized. While thermal print media is a preferred embodiment which has been tested and demonstrated to be effective on live mail, other technologies which are visually sensitive to sterilization can be employed. Cut-out patterns or opaque inks are interchangeable, depending on the materials and applications, and can be employed to add a level of security to help prevent forged safe mail indicators. Changing gray scale levels or barcode readability may be utilized for automated recognition of inadequate irradiation treatments. The irradiation status areas can be applied to various mail pieces, including envelopes, contents, packages postcards, pre-prepared inserts, and the like. The irradiation status area can be applied to any substrate depending on the specific application. By employing color changes, images, such as messages, are converted from one mode to another mode when a mail piece is sterilized. Cut-out indicia patterns can be selected, including those which are difficult to counterfeit. Techniques where encrypted information is converted from one mode to another mode when a mail piece is sterilized can be employed. Since postage meter indicia are created using encryption algorithms, the secure features of those indicia can be utilized to detect “forged” indicia intended by terrorists to mimic legitimate irradiation detection labels.

The use of white, black or other color inks printed on top of irradiation status allow images of messages to appear or disappear after irradiation. Some media such as thermal media, can turn virtually black as an irradiation indicator. A solarisation effect on certain graphic images can retain the graphic shape while converting it to a new visual form as a security feature. Solarisation is a phenomenon first employed in photography in which the image recorded on a negative or on a photographic print is wholly or partially reversed in tone. Dark areas appear light and vice versa. This solarisation-like effect in the present system is that the thermal printing of an image on a thermal label and the subsequent irradiation of the label does not necessarily result in the otherwise predicted simple summing of the darkening effects.

The technique of the present system reassures mail recipients and other people who are involved with the mail that the changes in the nature of a mail piece after irradiation are not a cause for alarm but an indication of safety of the mail. Continuously graded responses, such as gray levels, can be provided as measure of the irradiation dose a mail piece has received. Also, barcode or other coding degradation or enhancement, depending on how implemented, can be employed as a means to automatically process irradiated mail differently or to rerun inadequately treated mail.

The system can be employed to create and to send messages that can only be seen when an irradiation status area is treated with heat or radiation of some kind. This feature could be used for authentication. For example, coupons can be printed with a superimposed authentication mark from the coupon provider which could be verified at the time the customer uses the coupon. This could be a useful tool in direct marketing programs involving coupons and the like. Also, the system can be employed to report exposure to adverse environmental conditions. If a mail piece, such as a package, is being processed that must not be exposed to certain temperature conditions and has an irradiation status area on it, the condition of the irradiation status area at the end of its journey could be employed to verify the temperature conditions the package was exposed to. For example, we could code the temperature ranges on the irradiation status area and changes to the irradiation status area would signal the temperature conditions to which the mail piece was exposed.

While the present invention has been disclosed and described with reference to various specific embodiments thereof, it will be apparent, as noted above, that variations and modifications may be made therein. It is, thus, intended in the following claims to cover each variation and modification that falls within the true spirit and scope of the present invention.

What is claimed is:

1. A mail piece having a sterilization indicator, comprising:
an irradiation status area applied to a part of said mail piece;
said irradiation status area adapted to be activated by radiation;
said irradiation status area having a first color prior to activation by radiation; and,
said irradiation status area having a second color subsequent to activation by radiation.

2. A mail piece having a sterilization indicator as defined in claim 1 wherein said activating radiation are x-rays.

3. A mail piece having a sterilization indicator as defined in claim 1 wherein said activating radiation is radiant heat.

4. A mail piece having a sterilization indicator as defined in claim 1 wherein said mail piece has an outer surface and said part of said mail piece to which said irradiation status area is applied is said mail piece outer surface.

5. A mail piece having a sterilization indicator as defined in claim 1 wherein said mail piece has an outer surface and mail piece contents, said mail piece contents at least partially enclosed by said mail piece outer surface and said part of said mail piece to which said radiation status area is applied is said mail piece contents

6. A mail piece having a sterilization indicator as defined in claim 1 further including an image within said irradiation status area for providing a visual indication of the irradiation status of said mail piece.

7. A mail piece having a sterilization indicator as defined in claim 6 wherein said image within said irradiation status area is of a color such that the contrast between said image and said irradiation status area increases when said irradiation status area has been radiated and is of said second color.

8. A mail piece having a sterilization indicator as defined in claim 6 wherein said image within said irradiation status area is of a color such that the contrast between said image and said irradiation status area decreases when said irradiation status area has been radiated and is of said second color.

9. A mail piece having a sterilization indicator as defined in claim 6 wherein said image within said irradiation status area is formed by an ink on said irradiation status area.

10. A mail piece having a sterilization indicator as defined in claim 6 wherein said image within said irradiation status area is formed by a cut-out of a portion of said irradiation status area.

11. A mail piece having a sterilization indicator as defined in claim 1 further including a barcode within said irradiation status area for providing an indication of the radiation status of said mail piece and adapted to be employed in the processing of said mail piece by mail processing systems.

12. A mail piece having a sterilization indicator as defined in claim 11 wherein said barcode within said irradiation status area is of a color such that the contrast between said barcode and said irradiation status area increases when said irradiation status area has been radiated and is of said second color.

13. A mail piece having a sterilization indicator as defined in claim 11 wherein said barcode within said irradiation status area is of a color such that the contrast between said barcode and said irradiation status area decreases when said irradiation status area has been radiated and is of said second color.

14. A mail piece having a sterilization indicator as defined in claim 1 further including:
a second irradiation status area applied to a part of said mail piece;
said second irradiation status area adapted to be activated by radiation;
said second irradiation status area having a first color prior to activation by radiation; and,
said second irradiation status area having a second color subsequent to activation by radiation.

15. A mail piece having a sterilization indicator as defined in claim 14 further including a first image within said irradiation status area for providing a visual indication of the radiation status of said mail piece and including a second image within said second irradiation status area for providing a visual indication of the radiation status of said mail piece.

16. A mail piece having a sterilization indicator as defined in claim 15 wherein said image within said irradiation status area is of a color such that the contrast between said image and said irradiation status area increases when said irradiation status area has been radiated and is of said second color and wherein said image within said second irradiation status area is of a color such that the contrast between said image and said irradiation status area decreases when said irradiation status area has been radiated and is of said second color.

17. A mail piece having a sterilization indicator as defined in claim 16 wherein said image within said irradiation status area is a message indicating that said mail piece has been radiated and wherein said image within said second irradiation status area is a message indicating that said mail piece has not been radiated.

18. A mail piece having a sterilization indicator as defined in claim 1 wherein said irradiation status area second color subsequent to activation by radiation is determined by the level of said activating radiation and further including a color scale applied to a part of said mail piece, said color scale not subject to color change by irradiation and providing a color scale of the level of irradiation of said mail piece.

19. A mail piece having a sterilization indicator as defined in claim 18 wherein part of said mail piece to which said color scale is applied is adjacent said part of said mail piece to which said irradiation status area is applied.

20. A method for the processing a mail piece having a sterilization indicator, comprising the steps of:
introducing said mail piece into a postal processing system, said mail piece having an irradiation status area, said irradiation status area adapted to be activated by radiation;
radiating said mail piece; and,
processing said mail piece to determine whether said radiation has activated said irradiation status area.

21. A method for the processing a mail piece having a sterilization indicator as defined in claim 20 wherein said mail piece status area includes a barcode and wherein said processing said mail piece to determine whether said radiation has activated is by the readability of said barcode in said irradiation status area after radiation of said mail piece.

22. A method for processing a mail piece having a sterilization indicator as defined in claim 21 wherein the color contrast between said barcode and said irradiation status area changes when said irradiation status area has been radiated.

23. A method for processing a mail piece having a sterilization indicator as defined in claim 22 wherein the color contrast between said barcode and said irradiation status area increases when said irradiation status area has been radiated.

24. A method for processing a mail piece having a sterilization indicator as defined in claim 23 wherein said mail piece includes a second irradiation status area and said second irradiation status area includes a barcode and wherein said processing said mail piece to determine whether said radiation has activated includes the readability of said barcode in said second irradiation status area after radiation of said mail piece.

25. A method for processing a mail piece having a sterilization indicator as defined in claim 24 wherein said wherein the color contrast between said barcode and said second irradiation status area decreases when said second irradiation status area has been radiated.

26. A method for processing a mail piece having a sterilization indicator as defined in claim 20 wherein processing said mail piece to determine whether said radiation has activated said irradiation status area includes determining the color of the irradiation status area after radiation.

27. A method for processing a mail piece having a sterilization indicator as defined in claim 20 wherein said irradiation status area is on a label applied to said mail piece.

28. A method for processing a mail piece having a sterilization indicator as defined in claim 20 further comprising the step of imaging said mail piece.

29. A method for processing a mail piece having a sterilization indicator as defined in claim 20 wherein said irradiation status area is on a label applied to said mail piece and further comprising the steps of applying said label to said mail piece prior to any irradiation of said mail piece, and imaging said mail piece prior to any irradiation of said mail piece.
